(19) United States
(12) Patent Application Publication
(10) Pub. No.: US 2015/0258749 A1
(43) Pub. Date: Sep. 17, 2015

(54) Composite Material with Patterns

(71) Applicant: GLOBALTEX INDUSTRIAL CO., LTD., Taichung City (TW)

(72) Inventor: Chien-Pin Chang, Taichung City (TW)

(73) Assignee: GLOBALTEX INDUSTRIAL CO., LTD., Taichung City (TW)

(21) Appl. No.: 14/203,707

(22) Filed: Mar. 11, 2014

(51) Int. Cl. B32B 7/12; B32B 9/02; B32B 5/02; B32B 3/26

(52) U.S. Cl. CPC B32B 7/12; B32B 3/266; B32B 9/025; B32B 5/022; B32B 2479/00; B32B 2439/00; B32B 2437/00; B32B 2437/02; B32B 2307/7265

(57) ABSTRACT

A composite material with patterns contains a pattern layer, a base layer, and a hot-melt adhesive layer. The pattern layer includes patterns printed on a surface thereof and a plurality of first pores defined thereon. The base layer adheres with the pattern layer and includes a plurality of second pores arranged therein. The hot-melt adhesive layer is adhered between the pattern layer and the base layer and is hot pressed to generate a hot melt adhesive, and the hot melt adhesive penetrates into the plurality of first pores and the plurality of second pores, such that the pattern layer is adhered with the base layer securely. Thereby, the composite material has waterproof property, anti-contamination function, a long service life, and aesthetics appearance. In addition, the composite material is manufactured at a low cost.

### FIELD OF THE INVENTION

The present invention relates to a composite material with patterns which has waterproof property, anti-contamination function, a long service life, and aesthetics appearance.

### BACKGROUND OF THE INVENTION

A conventional composite material is employed to manufacture a product, such as a handbag, a purse, shoes or furniture, wherein patterns are manually adhered or printed on a base layer of the product. However, when the patterns have various colors, manufacturer has to prepare a plurality of printing plates for printing the patterns of various colors on the product, thus increasing production cost. Likewise, the conventional composite material cannot prevent water and contamination, and the patterns will remove from the product easily.

The patterns can be printed on a paper, for example, it is transfer printed on a surface of the base layer of the paper by hot pressing. Nevertheless, a material of the base layer is limited, and the patterns transferred printed on the paper are not colorful.

The patterns can be also inkjet printed on the surface of the product, but they cannot be inkjet printed on the surface of the product securely.

The present invention has arisen to mitigate and/or obviate the afore-described disadvantages.

### SUMMARY OF THE INVENTION

The primary objective of the present invention is to provide a composite material with patterns which has waterproof property, anti-contamination function, a long service life, and aesthetics appearance.

Another objective of the present invention is to provide a composite material with patterns which is manufactured at a low cost.

### BRIEF DESCRIPTION OF THE DRAWINGS

FIG. 1 is a plan view showing a part of the assembly of a composite material with patterns according to a first embodiment of the present invention.

FIG. 2 is a cross sectional view showing a part of the assembly of the composite material with the patterns according to the first embodiment of the present invention.

FIG. 3 is another cross sectional view showing a part of the assembly of the composite material with the patterns according to the first embodiment of the present invention.

FIG. 4 is a cross sectional view showing a part of the assembly of the composite material with the patterns according to a second embodiment of the present invention.

### DETAILED DESCRIPTION OF THE PREFERRED EMBODIMENTS

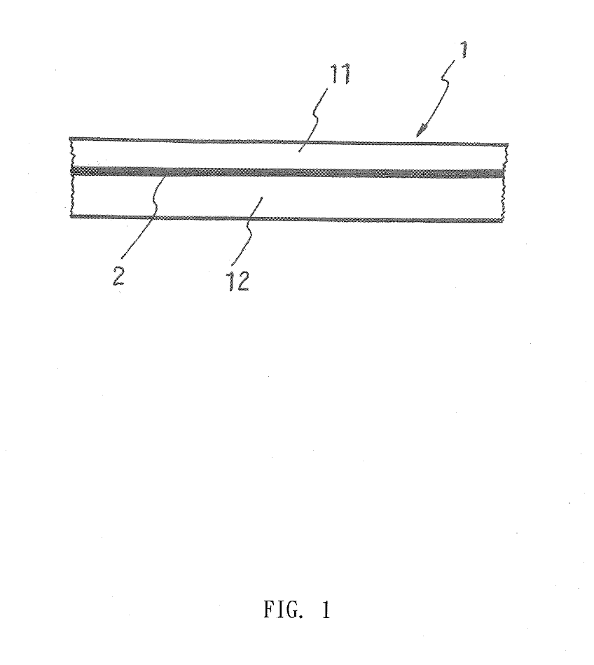

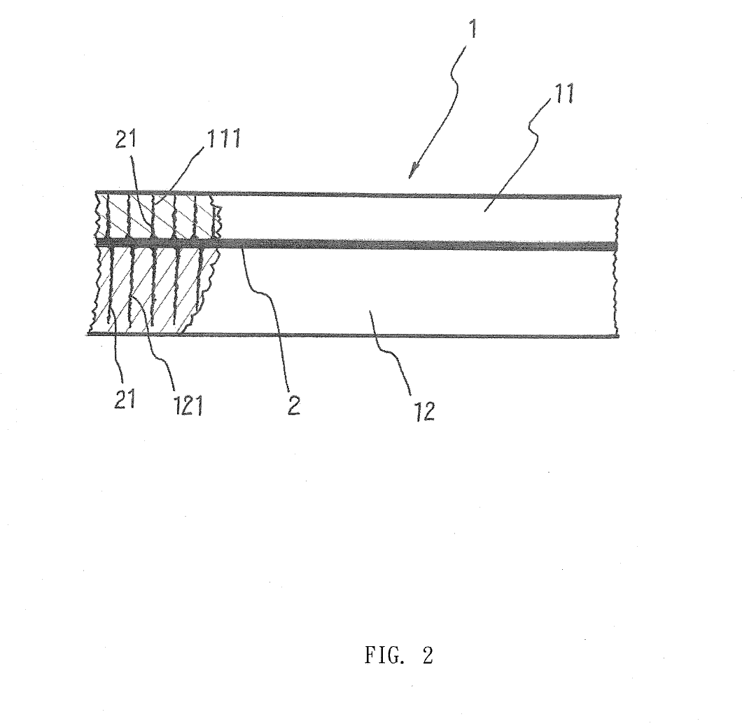

With reference to FIGS. 1 and 2, a composite material 1 with patterns according to a first embodiment of the present invention comprises:

a pattern layer 11 formed on a surface of the composite material 1 and including patterns printed on a surface thereof and a plurality of first pores 111 defined thereon;

a hot-melt adhesive layer 2 penetrated into the pattern layer 11 so as to enhance adhesion strength and to prevent contamination and water, wherein the hot-melt adhesive layer 2 is a paper product (such as a rice paper);

a base layer 12 being any one of textile, leather, knitted and woven textile, and nonwoven fabric, the base layer 12 adhering with the pattern layer 11 and including a plurality of second pores 121 for flowing the hot-melt adhesive layer 2 so as to increase adhesion strength.

The hot-melt adhesive layer 2 is any one of EVA, polyolefin, polyamide, PUR, PU, TPU and TPEE and is adhered between the pattern layer 11 and the base layer 12, wherein the hot-melt adhesive layer 2 is hot pressed to generate hot melt adhesive 21 and includes a plurality of third pores arranged therein, and then the hot melt adhesive 21 penetrates into the plurality of first pores 111 and the plurality of second pores 121, such that the pattern layer 11 is adhered with the base layer 12.

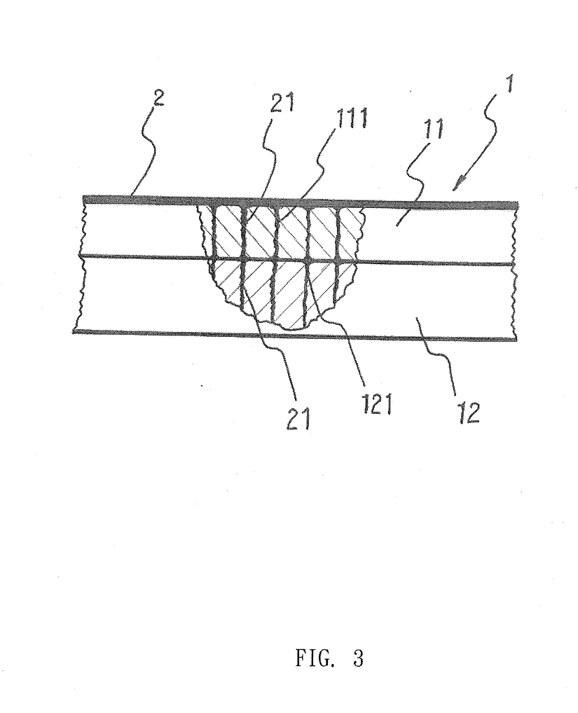

Referring further to FIG. 3, the hot-melt adhesive layer 2 is coated on the pattern layer 11 and then is hot pressed to generate the hot melt adhesive 21, thereafter the hot melt adhesive 21 penetrates into the plurality of first pores 111 and the plurality of second pores 121, such that the pattern layer 11 is adhered with the base layer 12 securely.

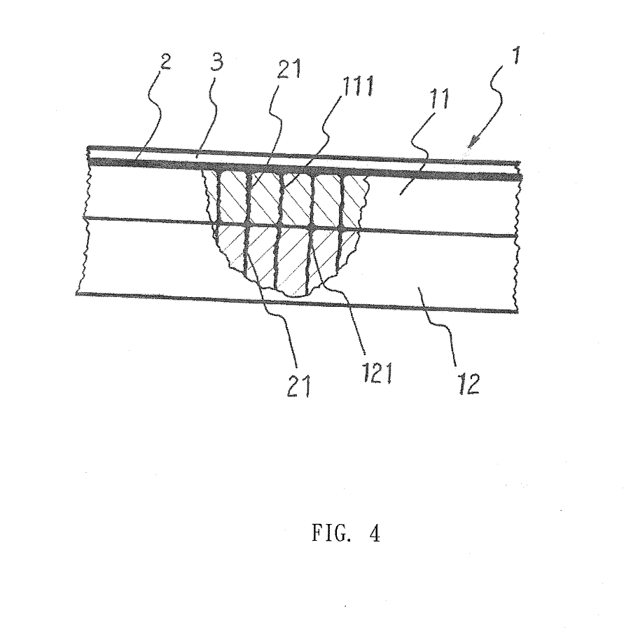

As shown in FIG. 4, a composite material 1 with patterns according to a second embodiment of the present invention comprises: a hot-melt adhesive layer 2 attaching with a waterproof film 3 (i.e., any one of EVA, polyolefin, polyamide, PUR, PU, TPU, and TPEE) and arranged on a pattern layer 11, wherein the hot-melt adhesive layer 2 is hot pressed to generate hot melt adhesive 21, and then the melt adhesive 21 penetrates into a plurality of first pores 111 of the pattern layer 11 and a plurality of second pores 121 of a base layer 12, such that the pattern layer 11 is adhered with the base layer 12 securely.

Thereby, the composite material of the prevent invention has waterproof property, anti-contamination function, a long service life, and aesthetics appearance. In addition, the composite material of the prevent invention is manufactured at a low cost.

While we have shown and described various embodiments in accordance with the present invention, it is clear to those skilled in the art that further embodiments may be made without departing from the scope of the present invention.

What is claimed is:

1. A composite material with patterns comprising:
a pattern layer formed on a surface of a composite material and including a plurality of first pores defined thereon;
a base layer adhering with the pattern layer and including a plurality of second pores;
a hot-melt adhesive layer adhered between the pattern layer and the base layer, the hot-melt adhesive layer including a plurality of third pores arranged therein and being hot pressed to generate hot melt adhesive, the hot melt adhesive penetrating into the plurality of first pores and the plurality of second pores, such that the pattern layer is adhered with the base layer securely.

2. The composite material with the patterns as claimed in claim 1, wherein the pattern layer includes patterns printed on a surface thereof.

3. The composite material with the patterns as claimed in claim 1, wherein the base layer is textile.

4. The composite material with the patterns as claimed in claim 1, wherein the base layer is leather.

5. The composite material with the patterns as claimed in claim 1, wherein the base layer is nonwoven fabric.

6. The composite material with the patterns as claimed in claim 1, wherein the hot-melt adhesive layer is coated on the pattern layer and then is hot pressed.

7. The composite material with the patterns as claimed in claim 1, wherein the hot-melt adhesive layer attaches with a waterproof film and is hot pressed on the pattern layer.

8. The composite material with the patterns as claimed in claim 7, wherein the waterproof film is EVA.

9. The composite material with the patterns as claimed in claim 7, wherein the waterproof film is polyolefin.

10. The composite material with the patterns as claimed in claim 7, wherein the waterproof film is polyamide.

11. The composite material with the patterns as claimed in claim 7, wherein the waterproof film is PUR.

12. The composite material with the patterns as claimed in claim 7, wherein the waterproof film is PU.

13. The composite material with the patterns as claimed in claim 7, wherein the waterproof film is TPU.

14. The composite material with the patterns as claimed in claim 7, wherein the waterproof film is TPEE.
